(19) United States
(12) Patent Application Publication
(10) Pub. No.: US 2026/0169273 A1
(43) Pub. Date: Jun. 18, 2026

(54) LENS UNIT AND CAMERA SYSTEM

(71) Applicant: FUJIFILM Corporation, Tokyo (JP)

(72) Inventors: Ryoko TOMIOKA, Saitama-shi (JP); Hiroki SAITO, Saitama-shi (JP)

(73) Assignee: FUJIFILM Corporation, Tokyo (JP)

(21) Appl. No.: 19/535,012

(22) Filed: Feb. 10, 2026

Related U.S. Application Data
(62) Division of application No. 18/183,126, filed on Mar. 13, 2023.

(30) Foreign Application Priority Data
Mar. 30, 2022 (JP) 2022-057533

(51) Int. Cl. G02B 15/14; G02B 13/02; G03B 7/0993

(52) U.S. Cl. CPC G02B 15/145121; G02B 13/02; G03B 7/0993

(57) ABSTRACT

A lens unit includes a variable magnification optical system provided with a stop that adjusts a light amount and a processor that controls an opening amount of the stop based on information on a magnification change of the variable magnification optical system. In a case where a maximum value and a minimum value of an F-Number in the entire variable magnification region of the variable magnification optical system are respectively Fmax and Fmin and an average value of an F-Number at a wide angle end and an F-Number at a telephoto end of the variable magnification optical system is Fave, the processor is configured to control the opening amount within a range satisfying 3<{(Fmax−Fmin)/Fave}×100<10.

### CROSS-REFERENCE TO RELATED APPLICATIONS

This application is a divisional of U.S. patent application Ser. No. 18/183,126, filed on Mar. 13, 2023, claims priority from Japanese Patent Application No. 2022-057533, filed on Mar. 30, 2022, the entire disclosures of which are incorporated herein by reference.

### BACKGROUND OF THE INVENTION

### Technical Field

The technique of the present disclosure relates to a lens unit and a camera system.

### Related Art

In a variable magnification optical system such as a zoom lens, an F-Number may change even though an opening amount of a stop is invariable during changing magnification. In a case where the F-Number changes, brightness of a captured image changes. JP2019-207334A and JP2021-043260A describe a lens device that controls an opening amount of a stop based on a position of a zoom lens group. Further, JP2020-034779A describes an optical device that controls a stop position of a stop unit according to a zoom state.

### SUMMARY

An object of the present disclosure is to provide a lens unit and a camera system capable of reducing a change in brightness of a captured image during changing magnification while suppressing an increase in a load on a control system as compared with the related art.

A lens unit according to an aspect of the present invention comprises a variable magnification optical system provided with a stop that adjusts a light amount, and a processor that controls an opening amount of the stop based on information on a magnification change of the variable magnification optical system, the processor controlling the opening amount within a range satisfying Conditional Expression (1) represented by

$$3 < \{ ( F max - F min ) / Fave \} \times 100 < 10 \qquad ( 1 )$$

in a case where a maximum value of an F-Number in an entire variable magnification region of the variable magnification optical system is Fmax, a minimum value of the F-Number in the entire variable magnification region of the variable magnification optical system is Fmin, and an average value of an F-Number at a wide angle end and an F-Number at a telephoto end of the variable magnification optical system is Fave.

In a case where the opening amount is changed, it is preferable that the processor changes the opening amount within a range satisfying Conditional Expression (2) represented by

$$0.05 < \vert F 1 - F 0 \vert < 1 \qquad ( 2 )$$

in a case where an F-Number of the variable magnification optical system before the change in the opening amount is F0, and an F-Number of the variable magnification optical system after the change in the opening amount is F1. In that case, it is more preferable that the following Conditional Expression (2-1) is satisfied instead of Conditional Expression (2), and it is still more preferable that the following Conditional Expression (2-2) is satisfied.

$$0.05 < \vert F 1 - F 0 \vert < 0.75 \qquad ( 2 - 1 )$$

$$0.05 < \vert F 1 - F 0 \vert < 0.5 \qquad ( 2 - 2 )$$

In a case where the opening amount is changed, it is preferable that the processor changes the opening amount within a range satisfying Conditional Expression (3) represented by

$$\vert ( V 1 - V 0 ) / V 0 \vert \times 100 < 20 \qquad ( 3 )$$

in a case where a peripheral light amount ratio at a maximum image height of the variable magnification optical system before the change in the opening amount is V0, and a peripheral light amount ratio at the maximum image height of the variable magnification optical system after the change in the opening amount is V1. In that case, it is more preferable to satisfy the following Conditional Expression (3-1) instead of Conditional Expression (3).

$$\vert ( V 1 - V 0 ) / V 0 \vert \times 100 < 15 \qquad ( 3 - 1 )$$

In a case where a maximum value and a minimum value of a peripheral light amount ratio at a maximum image height of the variable magnification optical system in each variable magnification region in which the opening amount is invariable are respectively Vmax and Vmin, it is preferable that the processor changes the opening amount within a range satisfying Conditional Expression (4) represented by

$$V max / V min < 3.5 \qquad ( 4 )$$

in a plurality of variable magnification regions in which the opening amount is invariable. In that case, it is more preferable that the following Conditional Expression (4-1) is satisfied instead of Conditional Expression (4), and it is still more preferable that the following Conditional Expression (4-2) is satisfied.

$$V max / V min < 3 \qquad ( 4 - 1 )$$

$$V max / V min < 2 \qquad ( 4 - 2 )$$

Further, it is preferable that the processor changes the opening amount within the range satisfying Conditional Expression (4) represented by

$$V max / V min < 3.5 \qquad ( 4 )$$

in all of the variable magnification regions in which the opening amount is invariable.

In a case where a maximum variable magnification ratio of the variable magnification optical system is ZRmax and a variable magnification ratio of the variable magnification optical system is ZR,
it is preferable that the F-Number of the variable magnification optical system takes Fmax and Fmin in a variable magnification region of 0.15<{log₁₀(ZR)/log₁₀(ZRmax)}<0.85.

In a case where a maximum variable magnification ratio of the variable magnification optical system is ZRmax and a variable magnification ratio of the variable magnification optical system is ZR, it is preferable that the opening amount is invariable in variable magnification regions of

$$0 < \{ {log}_{10} ( ZR ) / {log}_{10} ( ZR max ) \} < 0.15 , and$$

$$0.85 < \{ {log}_{10} ( ZR ) / {log}_{10} ( ZR max ) \} < 1.$$

In a case where the maximum variable magnification ratio of the variable magnification optical system is ZRmax and the variable magnification ratio of the variable magnification optical system is ZR, it is preferable that a variable magnification region in which the opening amount is changeable is

$$0.15 < \{ {log}_{10} ( ZR ) / {log}_{10} ( ZR max ) \} < 0.85 .$$

A minimum value of a peripheral light amount ratio at a maximum image height of the variable magnification optical system in the entire variable magnification region of the variable magnification optical system may be configured to be smaller than 40% or may be configured to be smaller than 35%.

A peripheral light amount ratio at a maximum image height of the variable magnification optical system at the wide angle end of the variable magnification optical system may be configured to be smaller than 50% or may be configured to be smaller than 45%.

The variable magnification optical system may be configured to consist of, in an order from an object side to an image side, a first lens group having a positive refractive power, a second lens group having a negative refractive power, a third lens group having a positive refractive power, a fourth lens group having a negative refractive power, and a fifth lens group having a positive refractive power. All of spacings between adjacent lens groups may be configured to change during changing magnification. The stop may be configured to be disposed between a surface of the second lens group closest to the object side and a surface of the fourth lens group closest to the image side.

A camera system according to an aspect of the present invention comprises a variable magnification optical system provided with a stop that adjusts a light amount, a detection unit that detects a variable magnification state of the variable magnification optical system, and a processor that controls an opening amount of the stop based on a detection result of the detection unit, the processor controlling the opening amount within a range satisfying Conditional Expression (1) represented by

$$3 < \{ ( F max - F min ) / Fave \} \times 100 < 10 \qquad ( 1 )$$

in a case where a maximum value of an F-Number in an entire variable magnification region of the variable magnification optical system is Fmax, a minimum value of the F-Number in the entire variable magnification region of the variable magnification optical system is Fmin, and an average value of an F-Number at a wide angle end and an F-Number at a telephoto end of the variable magnification optical system is Fave.

According to the present disclosure, there is provided the lens unit and the camera system capable of reducing the change in brightness of the captured image during changing the magnification while suppressing an increase in the load on the control system as compared with the related art.

### BRIEF DESCRIPTION OF THE DRAWINGS

FIG. 1 is a functional configuration diagram of an example of a camera system.

FIG. 2 is a diagram showing an example of table data.

FIG. 3 is a diagram showing an example of a relationship between a variable magnification ratio and an opening diameter.

FIG. 4 is a diagram showing an example of a relationship between the variable magnification ratio and an F-Number.

FIG. 5 is a diagram showing an example of a relationship between the variable magnification ratio and a peripheral light amount ratio.

FIG. 6 is a flowchart for describing processing of controlling the opening diameter.

FIG. 7 is a functional configuration diagram of a modification example of the camera system.

FIG. 8 is a cross-sectional view of a configuration of an example of a variable magnification optical system.

### DESCRIPTION OF EMBODIMENTS

Hereinafter, an embodiment of the present disclosure will be described with reference to drawings. In the following, an example of a lens-interchangeable digital camera will be described as an embodiment of the present disclosure.

### Camera System Configuration

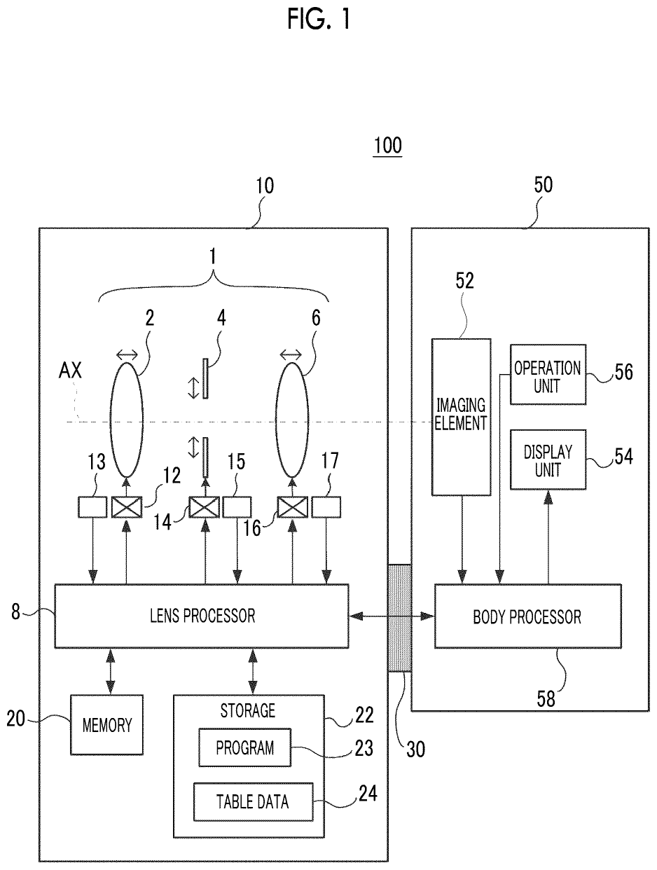

FIG. 1 shows a functional configuration diagram of a camera system 100 according to an embodiment of the present disclosure. The camera system 100 comprises a lens unit 10 and a camera body 50. The camera body 50 is provided with a mount 30 to which the lens unit 10 is attachably and detachably mounted. With the mounting of the lens unit 10 on the mount 30, the lens unit 10 and the camera body 50 are electrically connected to each other. Due to the electrical connection, a lens processor 8 in the lens unit 10 and a body processor 58 in the camera body 50 are in a state of being communicable with each other. The lens processor 8 is a processor that controls the lens unit 10, and the body processor 58 is a processor that controls the camera body 50. The lens processor 8 and the body processor 58 communicate with each other to control the camera system 100 in an integrated manner.

The lens unit 10 comprises a zoom lens 1, the lens processor 8, a variable magnification lens drive unit 12, a variable magnification state detection unit 13, a stop drive unit 14, an opening diameter detection unit 15, a focus lens drive unit 16, a focus detection unit 17, a memory 20, and a storage 22.

The zoom lens 1 is an example of a “variable magnification optical system” according to the technique of the present disclosure. The zoom lens 1 functions as an imaging lens for imaging a subject (not shown) and forms an image of the subject. The zoom lens 1 comprises a variable magnification lens 2, a stop 4, and a focus lens 6.

The variable magnification lens 2 moves along an optical axis AX to perform the magnification change of the zoom lens 1. Although the variable magnification lens 2 actually includes a plurality of lenses, the variable magnification lens 2 is conceptually shown in FIG. 1. A position of each lens included in the variable magnification lens 2 in an optical axis direction is set according to a variable magnification state.

The focus lens 6 moves along the optical axis AX to perform focusing of the zoom lens 1. The focus lens 6 may include a plurality of lenses, but FIG. 1 conceptually shows the focus lens 6.

Although FIG. 1 is a conceptual diagram and shows the variable magnification lens 2 and the focus lens 6 individually, a part of the variable magnification lens 2 may be configured as the focus lens 6. Further, the zoom lens 1 may comprise a lens that is not included in the variable magnification lens 2 and the focus lens 6.

The stop 4 has an opening portion in which an opening amount is variable and changes the opening amount to adjust an amount of light passing through the zoom lens 1. That is, with the change of the opening amount of the stop 4, an F-Number of the zoom lens 1 can be adjusted.

In the present example, the stop 4 has a plurality of stop leaf blades (not shown) disposed at spacings on a circumference centered on the optical axis AX and forms an annular light shielding portion as a whole. A portion radially inner of the light shielding portion is the opening portion and is a portion through which the light passes. With movement of the plurality of stop leaf blades in an opening/closing direction, the opening amount of the opening portion is changed. A shape of the opening portion in a plane perpendicular to the optical axis AX may be a circle centered on the optical axis AX or a polygon centered on the optical axis AX. In a case where the opening portion has the circular shape, a diameter of the circle is defined as an “opening diameter” of the stop 4. In a case where the opening portion has the polygonal shape, this polygon is approximated to a circle, and a diameter of the approximated circle is defined as the “opening diameter” of the stop 4. The opening amount can be detected by detecting the opening diameter, and the opening amount can be controlled by controlling the opening diameter.

The stop drive unit 14 drives the stop leaf blades of the stop 4 based on a control signal from the lens processor 8. With the driving of the stop leaf blades, the opening diameter of the stop 4 changes, and thus the opening amount changes. The stop drive unit 14 is configured to include, for example, an actuator such as a stepping motor or a voice coil motor.

The opening diameter detection unit 15 detects a position of the stop leaf blades related to the opening/closing direction, detects the opening diameter of the stop 4 based on the detected position, and outputs the opening diameter to the lens processor 8. The opening diameter detection unit 15 is configured to include, for example, an encoder such as a photo interrupter or a magnetic sensor. The opening diameter may be detected by another method. For example, the opening diameter may be indirectly detected by the lens processor 8 counting a drive pulse of the stepping motor constituting the stop drive unit 14. In this case, the lens processor 8 functions as the opening diameter detection unit 15.

The variable magnification lens drive unit 12 drives each lens included in the variable magnification lens 2 based on the control signal from the lens processor 8. The variable magnification lens drive unit 12 is configured to include, for example, an actuator such as the stepping motor.

The variable magnification state detection unit 13 detects a position of at least one lens included in the variable magnification lens 2 in the optical axis direction, detects the variable magnification state based on the detected position, and outputs information on the magnification change of the zoom lens 1 to the lens processor 8. The variable magnification state is a state or the like represented by, for example, a wide angle end, a telephoto end, or a variable magnification ratio. For example, the variable magnification ratio or a focal length can be used as the information on the magnification change. In a case where the focal length at the wide angle end is fw, the variable magnification ratio at a certain focal length fx is represented by fx/fw. The “variable magnification ratio” of the zoom lens 1 is also referred to as a “zoom ratio” or a “zoom magnification”.

The variable magnification state detection unit 13 is an example of a “detection unit” according to the technique of the present disclosure. The variable magnification state detection unit 13 may be configured to include, for example, a potentiometer, or a linear encoder, or may be configured to include a measurement device using a variable resistor and/or a laser beam. The variable magnification state may be detected by another method. For example, the variable magnification state may be detected based on a spacing between two lenses in the optical axis direction set in advance. Further, similarly to the detection of the opening diameter, the variable magnification state may be indirectly detected by the lens processor 8 counting the drive pulse of the stepping motor constituting the variable magnification lens drive unit 12. In this case, the lens processor 8 functions as the variable magnification state detection unit 13.

The focus lens drive unit 16 drives the focus lens 6 based on the control signal from the lens processor 8. The focus lens drive unit 16 is configured to include, for example, an actuator such as the stepping motor.

The focus detection unit 17 detects a position of the focus lens 6 in the optical axis direction and outputs information on the detected position to the lens processor 8.

The memory 20 is a work memory used for execution of a program 23 by the lens processor 8. The memory 20 is, for example, a random access memory (RAM). Examples of the RAM include a dynamic random access memory (DRAM) and a static random access memory (SRAM).

The storage 22 is a non-volatile storage device. Examples of the storage 22 include a non-volatile memory such as a flash memory, and data storage such as a solid state drive (SSD) and a hard disk drive (HDD). Various types of data such as the program 23 and table data 24 are stored in the storage 22.

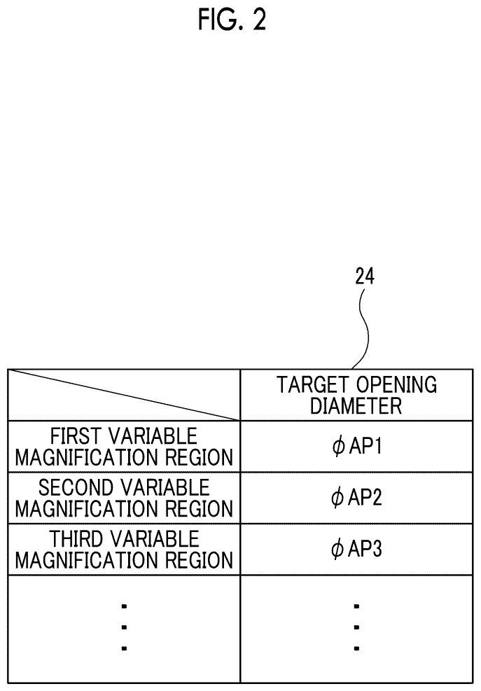

The table data 24 includes data in which the variable magnification state and the opening amount are associated with each other. The table data 24 is data referred to in a case where the lens processor 8 controls the opening amount of the stop 4. An example of the table data 24 is shown in FIG. 2. In the present embodiment, the entire variable magnification region is divided into a plurality of variable magnification regions such as a first variable magnification region, a second variable magnification region, a third variable magnification region, and the like in order from a wide angle side, and a target opening diameter is associated with each variable magnification region as shown in FIG. 2. The term “entire variable magnification region” in the present specification refers to a variable magnification region from the wide angle end to the telephoto end. The table data 24 shown in FIG. 2 is an example, and the target opening diameter may be associated with each variable magnification ratio or each focal length.

The lens processor 8 is an example of a “processor” according to the technique of the present disclosure. The lens processor 8 controls the opening amount of the stop 4 based on the information on the magnification change of the zoom lens 1 from the variable magnification state detection unit 13. The lens processor 8 refers to the table data 24 to acquire the target opening diameter according to the variable magnification state. In a case where the opening diameter is different from the target opening diameter, the lens processor 8 outputs the control signal to the stop drive unit 14 such that the opening diameter is the same as the target opening diameter.

The lens processor 8 outputs the signal to the variable magnification lens drive unit 12 and the focus lens drive unit 16 to control the drive of the variable magnification lens 2 and the focus lens 6. In addition, the lens processor 8 performs processing based on various control signals transmitted from the body processor 58. The lens processor 8 is, for example, a central processing unit (CPU) and cooperates with the memory 20 to control each unit in the lens unit 10 according to the program 23 and execute various types of processing.

The camera body 50 comprises an imaging element 52, the body processor 58, a display unit 54, and an operation unit 56.

The imaging element 52 captures an image formed by the zoom lens 1. For example, a charge coupled device (CCD) or a complementary metal-oxide semiconductor (CMOS) can be used as the imaging element 52. The imaging element 52 outputs a captured image, which is an image of the captured image, to the body processor 58.

The body processor 58 performs image processing on the captured image and outputs image data subjected to the image processing to the display unit 54. Further, the body processor 58 outputs image data related to various kinds of information to the display unit 54. The display unit 54 displays an image based on the signal from the body processor 58.

In the camera system 100, two modes of an autofocus mode and a manual focus mode can be selected for focusing. In a case in which the autofocus mode is selected, the body processor 58 performs autofocus processing based on the input captured image and outputs the signal for controlling the focus lens drive unit 16 to the lens processor 8. In a case where the manual focus mode is selected, the focus lens 6 is driven based on a user operation on a focus ring (not shown) for performing focus adjustment. The camera system 100 may be configured to include only one of the autofocus mode and the manual focus mode.

The operation unit 56 receives an operation input by the user. The operation unit 56 includes, for example, a zoom button, a release button, a dial, a cross-key type or control-wheel type selection button, and a touch panel provided on a display. The zoom button is a button pressed in a case where the user issues an instruction to perform the magnification change, and includes, for example, a wide button for issuing an instruction to perform zooming to the wide-angle side and a telephoto button for issuing an instruction to perform zooming to a telephoto side. The release button is pressed, for example, in a case where the user issues an instruction to store the captured image. The selection button and the touch panel are operated, for example, in a case where the user performs mode selection, condition setting, or the like. In a case where the user operates the operation unit 56, an operation signal is input to the body processor 58.

The body processor 58 controls each unit based on the operation signal. The body processor 58 outputs the control signal to the lens processor 8 according to a content of the operation signal. Although not shown, the body processor 58 is also connected to a memory (not shown) like the lens processor 8. The body processor 58 cooperates with the memory (not shown) to control each unit in the camera system 100 according to a control program and execute various types of processing according to various application programs.

In the present example, a central processing unit (CPU), which is a general-purpose processor that executes a program to execute various types of processing as the lens processor 8 and the body processor 58, is illustrated. However, of course, a processor other than the CPU is may be used. Examples of the processor other than the CPU include a programmable logic device (PLD) whose circuit configuration is changeable after manufacturing such as a field programmable gate array (FPGA) and a dedicated electric circuit having a circuit configuration exclusively designed to execute specific processing such as an application specific integrated circuit (ASIC). Further, one of these various processors may be used, or a combination of a plurality of processors may be used. A hardware structure of the various processors is, more specifically, circuitry in which circuit elements such as semiconductor elements are combined.

### Method of Controlling Opening Amount

Next, control of the opening amount in the camera system 100 will be described. The zoom lens 1 has a configuration in which the F-Number changes in a case where the magnification change is performed from the wide angle end to the telephoto end without changing the opening amount of the stop 4. In a case where the F-Number changes, brightness of a captured image changes. For example, in a case where a magnification change operation is performed during video imaging and the F-Number changes, the image brightness changes in the middle of the imaging. In a case where the change is large, exposure is out of proper exposure and the user will feel uncomfortable. Further, since depth of field also changes due to the change in the F-Number, an influence occurs in addition to the brightness. In the camera system 100, the control is performed as follows.

Regarding the F-Number, the lens processor 8 controls the opening amount within a range satisfying the following Conditional Expression (1).

$$3 < \{ ( F max - F min ) / Fave \} \times 100 < 10 \qquad ( 1 )$$

Definition of each symbol used in Conditional Expression (1) is as follows. Fmax is a maximum value of the F-Number in the entire variable magnification region of the zoom lens 1. Fmin is a minimum value of the F-Number in the entire variable magnification region of the zoom lens 1. Fave is an average value of the F-Number at the wide angle end and the F-Number at the telephoto end of the zoom lens 1. Specific values in the table data 24 shown in FIG. 2 are set to satisfy Conditional Expression (1).

With setting of a corresponding value of Conditional Expression (1) so as not to be equal to or larger than an upper limit, the change in the F-Number during changing magnification can be suppressed as compared with a case in the related art in which the control based on Conditional Expression (1) is not performed. Therefore, the change in the brightness of the captured image during changing the magnification can be reduced. As shown in the table data 24 as an example, the control of the opening amount is performed such that the entire variable magnification region is divided into the plurality of variable magnification regions and the target opening diameter is obtained in each variable magnification region. In this case, in a case where the number of divisions in the variable magnification region is large, the control becomes complicated, and the data capacity used for the control also becomes enormous. With setting of the corresponding value of Conditional Expression (1) so as not to be equal to or less than a lower limit, the complication of the control of the opening amount and an increase in the data capacity used for the control can be suppressed as compared with the case in the related art in which the control based on Conditional Expression (1) is not performed. Accordingly, the increase in the load on the control system can be suppressed.

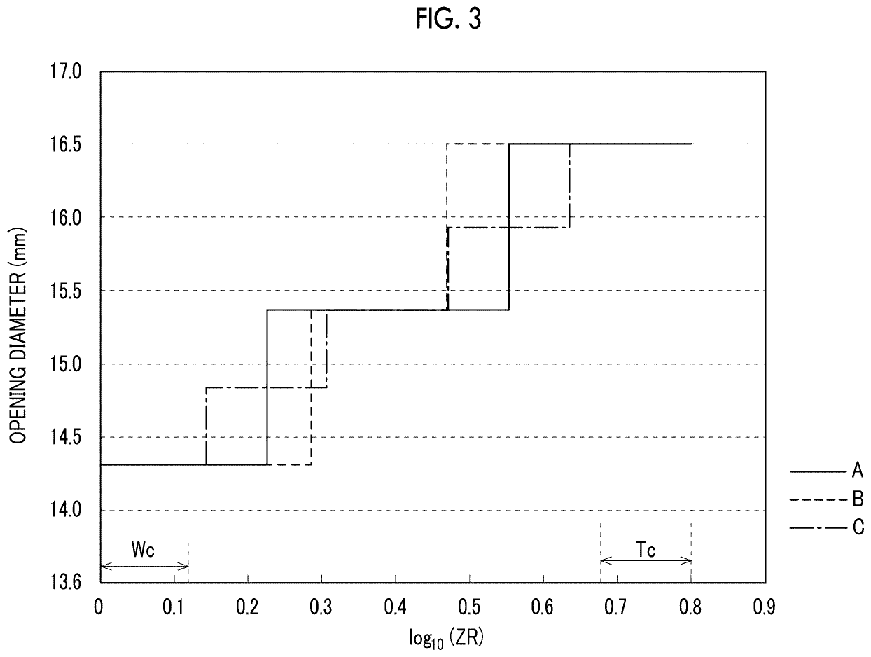

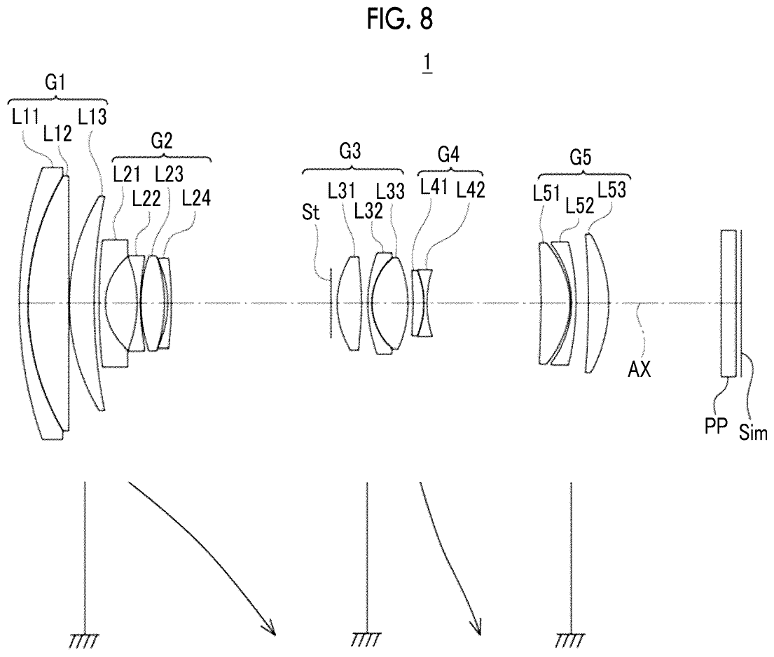

FIG. 3 shows an example of a relationship between the variable magnification ratio and the opening diameter in a case where the opening diameter is controlled such that the entire variable magnification region is divided into the plurality of variable magnification regions and the target opening diameter is associated with each divided variable magnification region. The example shown in FIG. 3 is based on an Example of the zoom lens 1 shown in FIG. 8. In FIG. 3, the variable magnification ratio is ZR and log₁₀(ZR) is taken on the lateral axis. log₁₀(ZR) is a logarithm of ZR having a base of 10. A maximum variable magnification ratio (variable magnification ratio at telephoto end) of the Example of FIG. 8 is 6.3, and FIG. 3 shows the data in the entire variable magnification region of the present Example. A point 0 on the lateral axis of FIG. 3 corresponds to the wide angle end, and a point 0.799 on the lateral axis corresponds to the telephoto end. The vertical axis of FIG. 3 is the opening diameter in a case where the unit is millimeter (mm).

In FIG. 3, three examples of an example A, an example B, and an example C in which the method of dividing the variable magnification regions is different are respectively shown by a solid line, a broken line, and a one-dot chain line. The example A is an example in which the entire variable magnification region is divided into three variable magnification regions for control. In a case where the divided variable magnification regions are the first variable magnification region, the second variable magnification region, the third variable magnification region, and the like in order from the wide angle side, a point at which a value on the lateral axis is 0.225 corresponds to a boundary between the first variable magnification region and the second variable magnification region and a point at which the value on the lateral axis is 0.553 corresponds to a boundary between the second variable magnification region and the third variable magnification region, in the example A.

The example B is also an example in which the entire variable magnification region is divided into three variable magnification regions for control, as in the example A. However, a point at a boundary of each divided variable magnification region, that is, a variable magnification ratio at the boundary of each divided variable magnification region is different from that of the example A. The example C is an example in which the entire variable magnification region is divided into five variable magnification regions for control. In the examples A, B, and C, the opening diameter is invariable within each of the divided variable magnification regions, and the opening diameter is controlled to change stepwise at the boundary of each variable magnification region.

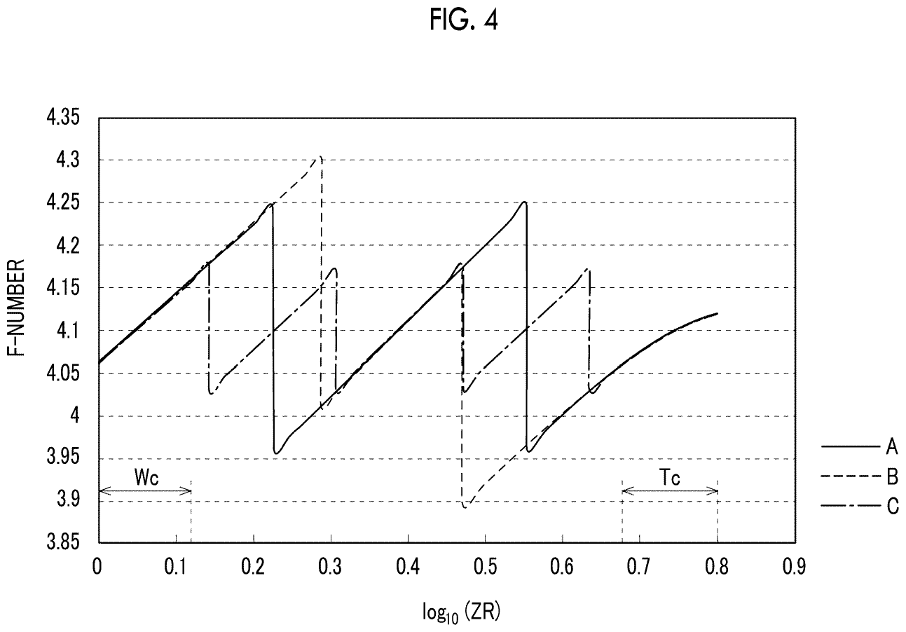

In the Example of the zoom lens 1 shown in FIG. 8, a relationship between the variable magnification ratio and the F-Number in a case where the control is performed as shown in FIG. 3 is shown in FIG. 4. The lateral axis of FIG. 4 is the same as the lateral axis of FIG. 3. The vertical axis of FIG. 4 is the F-Number. In FIG. 4, pieces of data related to the examples A, B, and C are respectively shown by a solid line, a broken line, and a one-dot chain line.

As shown in FIG. 4, in the examples A, B, and C, the F-Number also increases as the variable magnification ratio increases in the variable magnification region where the opening diameter is invariable, and the F-Number decreases in a case where the opening diameter is changed to increase by the variable magnification ratio corresponding to the boundary. During changing the magnification from the wide angle end to the telephoto end, with repetition of such an increase/decrease in the F-Number according to the number of divided variable magnification regions, the change in the F-Number is suppressed as a whole.

Table 1 shows values related to Conditional Expression (1) in the examples A, B, and C of FIG. 4. In Table 1, numerical values rounded with digits set in advance are shown, and this point is the same in the following table. In the examples A and B, the number of divisions in the variable magnification region and the target opening diameter are the same, but the variable magnification ratios corresponding to the boundaries of the divided variable magnification regions are different. Thus, an amount of change in the F-Number in the entire variable magnification region, that is, (Fmax−Fmin), is significantly different.

TABLE 1

| | | | | Fmax − | {(Fmax − Fmin)/ |
|---|---|---|---|---|---|
| | Fmax | Fmin | Fave | Fmin | Fave} × 100 |
| Column A | 4.25 | 3.96 | 4.09 | 0.29 | 7.09 |
| Column B | 4.30 | 3.90 | 4.09 | 0.40 | 9.78 |
| Column C | 4.18 | 4.03 | 4.09 | 0.15 | 3.67 |

Fmax and Fmin are preferably taken in the variable magnification region of

$$0.15 < \{ {log}_{10} ( ZR ) / {log}_{10} ( ZR max ) \} < 0.85$$

as the variable magnification region in which the F-Number of the zoom lens 1 has the maximum value and the minimum value. ZR is the variable magnification ratio of the zoom lens 1, ZRmax is the maximum variable magnification ratio of the zoom lens 1, and definitions of these symbols are the same in the following description.

In a case where the camera system 100 is used, in many cases, the zoom lens 1 is set to the variable magnification state on the wide angle side to search for the subject in a wide range, confirmation is made that the subject is included in the captured image, and then the variable magnification ratio is increased to image the subject in close-up. From the above, two variable magnification regions of a variable magnification region at the wide angle end and near the wide angle end and a variable magnification region at the telephoto end and near the telephoto end are considered to be frequently used. The variable magnification region of 0.15<{log₁₀(ZR)/log₁₀(ZRmax)}<0.85 can be generally regarded as a range obtained by subtracting the above two frequently used variable magnification regions from the entire variable magnification region. With a configuration in which the F-Number does not take the maximum value or the minimum value in the range, a sudden change in brightness does not occur in the range. Therefore, usability can be improved as compared with a case where such a configuration is not employed.

The opening amount is preferably invariable in the variable magnification regions of

$$0 < \{ {log}_{10} ( ZR ) / {log}_{10} ( ZR max ) \} < 0.15 , and$$

$$0.85 < \{ {log}_{10} ( ZR ) / {log}_{10} ( ZR max ) \} < 1$$

from the same circumstances as above. The opening amount needs to be invariable in each of the two variable magnification regions, and the opening amounts in the two variable magnification regions do not have to be the same. Further, the term “invariable” includes an error that is practically allowed in the technical field to which the technique of the present disclosure belongs. With the configuration in which the opening amount is generally invariant in the above two frequently used variable magnification regions, a sudden change in brightness does not occur in these two variable magnification regions. Therefore, usability can be improved as compared with a case where such a configuration is not employed.

In FIG. 3 and FIG. 4, a range indicated by Wc, which is near the wide angle end, corresponds to

$$0 < \{ {log}_{10} ( ZR ) / {log}_{10} ( ZR max ) \} < 0.15 ,$$

a range indicated by Tc, which is near the telephoto end, corresponds to

$$0.85 < \{ {log}_{10} ( ZR ) / {log}_{10} ( ZR max ) \} < 1.$$

Similarly, the variable magnification region in which the opening amount can be changed is preferably configured to be

$$0.15 < \{ {log}_{10} ( ZR ) / {log}_{10} ( ZR max ) \} < 0.85$$

from the same circumstances as above. With a configuration in which the variable magnification region in which the opening amount can be changed is limited to the above range, a sudden change in brightness does not occur in the above two frequently-used variable magnification regions. Therefore, usability can be improved as compared with a case where such a configuration is not employed.

In a case where the opening amount is changed, the lens processor 8 preferably controls the opening amount within a range satisfying the following Conditional Expression (2).

$$0.05 < \vert F 1 - F 0 \vert < 1 \qquad ( 2 )$$

Definition of each symbol used in Conditional Expression (2) is as follows. F0 is an F-Number of the zoom lens 1 before the change in the opening amount. F1 is an F-Number of the zoom lens 1 after the change in the opening amount. For example, in a case where the opening amount is changed in a state having a variable magnification ratio set in advance, F0 and F1 are values in a state having the variable magnification ratio set in advance.

With setting of a corresponding value of Conditional Expression (2) so as not to be equal to or larger than the upper limit, the amount of change in the F-Number before and after the change in the opening amount can be suppressed. The amount of change in brightness of the captured image before and after the change in the opening amount can be reduced. With setting of the corresponding value of Conditional Expression (2) so as not to be equal to or less than the lower limit, the same effect as in a case where the corresponding value of Conditional Expression (1) is set so as not to be the lower limit or less can be obtained.

A more preferable aspect is to satisfy the following Conditional Expression (2-1) instead of Conditional Expression (2), and a still more preferable aspect is to satisfy the following Conditional Expression (2-2) instead of Conditional Expression (2).

$$0.05 < \vert F 1 - F 0 \vert < 0.75 \qquad ( 2 - 1 )$$

$$0.05 < \vert F 1 - F 0 \vert < 0.5 \qquad ( 2 - 2 )$$

Table 2 shows values related to Conditional Expression (2) in the examples A, B, and C of FIG. 4. Table 2 also shows values of log₁₀(ZR) in a case of the opening diameter change.

TABLE 2

| | | | | Value of log₁₀(ZR) in |
|---|---|---|---|---|
| | | | | case of opening |
| | F0 | F1 | \|F1 − F0\| | diameter change |
| Column A | 4.248 | 3.961 | 0.287 | 0.225 |
| | 4.248 | 3.965 | 0.283 | 0.553 |
| Column B | 4.303 | 4.013 | 0.290 | 0.287 |
| | 4.176 | 3.895 | 0.281 | 0.471 |
| Column C | 4.177 | 4.030 | 0.147 | 0.143 |
| | 4.171 | 4.031 | 0.140 | 0.307 |
| | 4.176 | 4.033 | 0.143 | 0.471 |
| | 4.170 | 4.031 | 0.139 | 0.635 |

By the way, in an image captured by a general imaging lens, a peripheral portion of the image is darker than a central portion of the image. Thus, the brightness of the peripheral portion of the image is also preferably considered as the brightness of the captured image. For this reason, in a case where the opening amount is changed, the lens processor 8 preferably controls the opening amount within a range satisfying the following Conditional Expression (3).

$$\vert ( V 1 - V 0 ) / V 0 \vert \times 100 < 20 \qquad ( 3 )$$

Definition of each symbol used in Conditional Expression (3) is as follows. V0 is a peripheral light amount ratio at a maximum image height of the zoom lens 1 before the change in the opening amount. V1 is a peripheral light amount ratio at a maximum image height of the zoom lens 1 after the change in the opening amount. For example, in a case where the opening amount is changed in a state having a variable magnification ratio set in advance, V0 and V1 are values in a state having the variable magnification ratio set in advance. With the satisfaction of Conditional Expression (3), the change in brightness in the peripheral portion of the image during changing the magnification can be suppressed.

A more preferable aspect is to satisfy the following Conditional Expression (3-1) instead of Conditional Expression (3).

$$\vert ( V 1 - V 0 ) / V 0 \vert \times 100 < 15 \qquad ( 3 - 1 )$$

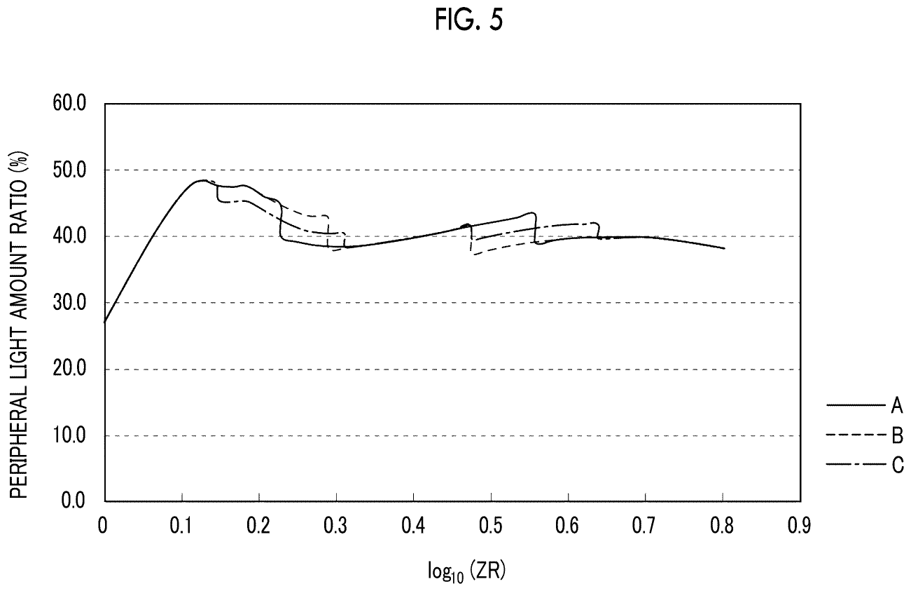

In the Example of the zoom lens 1 shown in FIG. 8, a relationship between the variable magnification ratio and the peripheral light amount ratio in a case where the opening diameter is controlled as shown in FIG. 3 is shown in FIG. 5. The lateral axis of FIG. 5 is the same as the lateral axis of FIG. 3. The vertical axis of FIG. 5 is the peripheral light amount ratio at the maximum image height of the present Example in a case where the unit is % (percentage). In FIG. 5, pieces of data related to the examples A, B, and C are respectively shown by a solid line, a broken line, and a one-dot chain line.

Table 3 shows values related to Conditional Expression (3) in the examples A, B, and C of FIG. 5. Table 3 also shows the values of log₁₀(ZR) in a case of the opening diameter change.

TABLE 3

| | | | | | Value of log₁₀(ZR) in |
|---|---|---|---|---|---|
| | | | | \|(V1 − V0)/ | case of opening |
| | V0 | V1 | V1 − V0 | V0\|×100 | diameter change |
| Column A | 44.6 | 40.2 | −4.4 | 9.9 | 0.225 |
| | 43.2 | 39.0 | −4.2 | 9.7 | 0.553 |
| Column B | 42.6 | 38.3 | −4.3 | 10.1 | 0.287 |
| | 41.5 | 37.4 | −4.1 | 9.9 | 0.471 |
| Column C | 47.7 | 45.4 | −2.3 | 4.8 | 0.143 |
| | 40.3 | 38.3 | −2.0 | 5.0 | 0.307 |
| | 41.5 | 39.4 | −2.1 | 5.1 | 0.471 |
| | 41.8 | 39.8 | −2.0 | 4.8 | 0.635 |

In the present embodiment, the opening amount is also invariable in the variable magnification region in which the opening diameter is invariable. In a case where there is a variable magnification region in which the opening amount is invariable as in the example of FIG. 3, the lens processor 8 preferably controls the opening amount in a plurality of variable magnification regions in which the opening amount is invariable within a range satisfying the following Conditional Expression (4).

$$V max / V min < 3.5 \qquad ( 4 )$$

Definition of each symbol used in Conditional Expression (4) is as follows. Vmax and Vmin are respectively a maximum value and a minimum value of the peripheral light amount ratio at the maximum image height of the zoom lens 1 in each variable magnification region in which the opening amount is invariable. With the satisfaction of Conditional Expression (4), the change in brightness in the peripheral portion of the image during changing the magnification can be suppressed.

In order to better suppress the change in brightness in the peripheral portion of the image during changing the magnification, the lens processor 8 preferably controls the opening amount in all of the variable magnification regions in which the opening amount is invariable within the range satisfying Conditional Expression (4).

A more preferable aspect is to satisfy the following Conditional Expression (4-1) instead of Conditional Expression (4), and a still more preferable aspect is to satisfy the following Conditional Expression (4-2) instead of Conditional Expression (4).

$$V max / V min < 3 \qquad ( 4 - 1 )$$

$$V max / V min < 2 \qquad ( 4 - 2 )$$

Table 4 shows values related to Conditional Expression (4) in the examples A, B, and C of FIG. 5. In Table 4, in each example, the variable magnification regions in which the opening amount is invariable are set as the first variable magnification region, the second variable magnification region, the third variable magnification region, and the like in order from the wide angle side.

TABLE 4

| | | Vmax | Vmin | Vmax/Vmin |
|---|---|---|---|---|
| Column A | First variable | 48.4 | 27.3 | 1.8 |
| | magnification | | | |
| | region | | | |
| | Second variable | 43.2 | 38.3 | 1.1 |
| | magnification | | | |
| | region | | | |
| | Third variable | 39.9 | 38.2 | 1.0 |
| | magnification | | | |
| | region | | | |
| Column B | First variable | 48.4 | 27.3 | 1.8 |
| | magnification | | | |
| | region | | | |
| | Second variable | 41.5 | 38.3 | 1.1 |
| | magnification | | | |
| | region | | | |
| | Third variable | 39.9 | 37.4 | 1.1 |
| | magnification | | | |
| | region | | | |
| Column C | First variable | 48.4 | 27.3 | 1.8 |
| | magnification | | | |
| | region | | | |
| | Second variable | 45.4 | 40.3 | 1.1 |
| | magnification | | | |
| | region | | | |
| | Third variable | 41.5 | 38.3 | 1.1 |
| | magnification | | | |
| | region | | | |
| | Fourth variable | 41.8 | 39.4 | 1.1 |
| | magnification | | | |
| | region | | | |
| | Fifth variable | 39.9 | 38.2 | 1.0 |
| | magnification | | | |
| | region | | | |

In any of the examples A, B, and C shown in FIG. 5, the peripheral light amount ratio at the maximum image height is a minimum value of 27.3% in the entire variable magnification region at a point where log₁₀(ZR)=0 corresponding to the wide angle end.

As shown in the example of FIG. 5, the minimum value of the peripheral light amount ratio at the maximum image height of the zoom lens 1 in the entire variable magnification region may be configured to be smaller than 40%. Such a case is advantageous for reducing the diameter of the zoom lens 1. In order to further reduce the diameter of the zoom lens 1, the minimum value of the peripheral light amount ratio at the maximum image height of the zoom lens 1 in the entire variable magnification region is preferably configured to be smaller than 35%.

Further, the peripheral light amount ratio at the maximum image height of the zoom lens 1 at the wide angle end may be configured to be smaller than 50%. Such a case is also advantageous for reducing the diameter of the zoom lens 1. In order to further reduce the diameter of the zoom lens 1, the peripheral light amount ratio at the maximum image height of the zoom lens 1 at the wide angle end is preferably configured to be smaller than 45%.

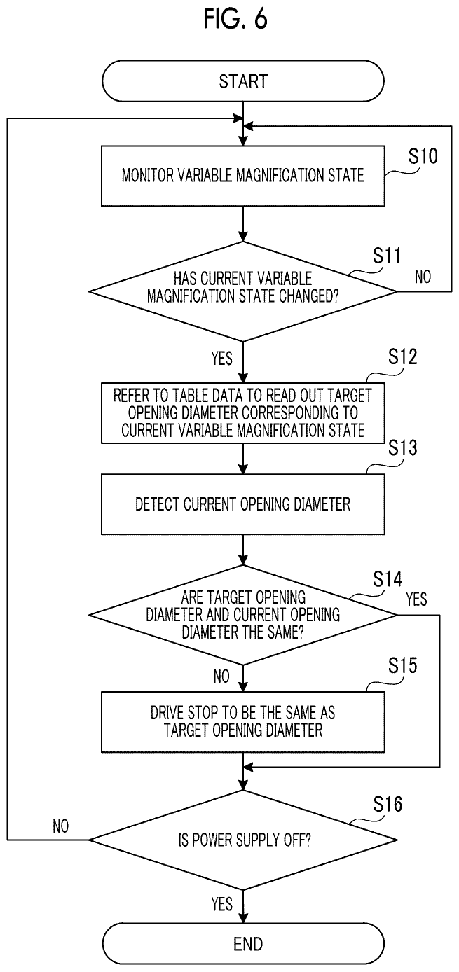

Next, processing of controlling the opening diameter will be described with reference to a flowchart of FIG. 6. In step S10, the lens processor 8 monitors the variable magnification state based on a signal output from the variable magnification state detection unit 13 as a detection result of the variable magnification state. For example, the lens processor 8 reads out the signal from the variable magnification state detection unit 13 at time intervals set in advance to monitor whether or not a current variable magnification state has changed from the variable magnification state at the time of the previous readout.

In step S11, the lens processor 8 determines whether or not the current variable magnification state has changed from the variable magnification state at the time of the previous readout. In a case where determination is made that the variable magnification state has not changed (step S11: NO), the lens processor 8 continues monitoring the variable magnification state.

In a case where determination is made that the variable magnification state has changed (step S11: YES), the lens processor 8 proceeds to step S12. In step S12, the lens processor 8 refers to the table data 24 to acquire the target opening diameter corresponding to the current variable magnification state. For example, in a case where the variable magnification ratio is used as the information on the variable magnification state, the lens processor 8 determines which variable magnification region of the first variable magnification region, the second variable magnification region, the third variable magnification region, and the like in the table data 24 a current variable magnification ratio corresponds to and acquires the target opening diameter associated with the corresponding variable magnification region.

In the control of the example of FIG. 3, in a case where the current variable magnification ratio corresponds to a value at the boundary of the divided variable magnification regions, the target opening diameter may be decided according to a direction of the magnification change. The direction of the magnification change is a direction from the wide angle side to the telephoto side or a direction from the telephoto side to the wide angle side. For example, in a case where the current variable magnification ratio corresponds to a value at a boundary between the first variable magnification region and the second variable magnification region, the target opening diameter associated with the second variable magnification region may be acquired in a case where the magnification change is performed from the wide angle side to the telephoto side, and the target opening diameter associated with the first variable magnification region may be acquired in a case where the magnification change is performed from the telephoto side to the wide angle side.

In step S13, the lens processor 8 detects the current opening diameter based on the signal output from the opening diameter detection unit 15.

In step S14, the lens processor 8 determines whether or not the target opening diameter acquired from the table data 24 and the detected current opening diameter are the same.

In a case where determination is made that the target opening diameter and the detected current opening diameter are the same (step S14: YES), the lens processor 8 proceeds to step S16. In a case where determination is made that the target opening diameter is different from the detected current opening diameter (step S14: NO), in step S15, the lens processor 8 outputs, to the stop drive unit 14, a control signal for causing the stop 4 to drive such that the opening diameter is the same as the target opening diameter.

In step S16, the lens processor 8 determines whether or not a power supply is off. In a case where determination is made that the power supply is off (step S16: YES), the processing ends. In a case where determination is made that the power supply is not off (step S16: NO), the processing proceeds to step S10.

### Modification Example of Camera System

Next, a modification example of the camera system will be described. In the above embodiment, the example in which the lens processor 8 performs the processing shown in FIG. 6 has been described, but different configurations are also possible. For example, the camera body 50 may be provided with the table data 24, the body processor 58 may perform the processing shown in FIG. 6, the body processor 58 may transmit the signal for driving the stop 4 to the lens processor 8, and the lens processor 8 may output the control signal for driving the stop 4 to the stop drive unit 14 based on the signal. That is, the “processor” that controls the opening amount of the stop 4 according to the technique of the present disclosure may be realized by a combination of the lens processor 8 and the body processor 58.

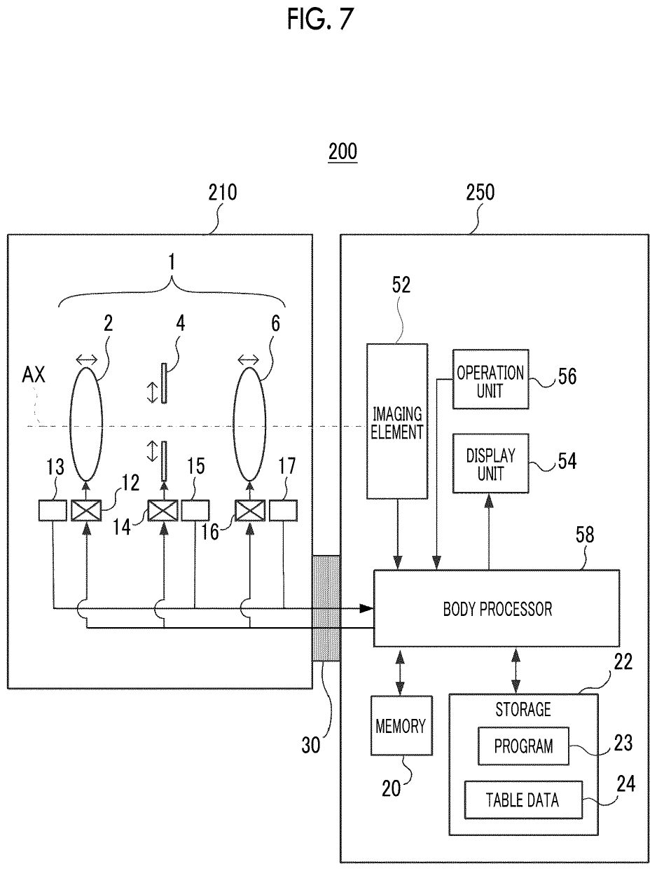

Alternatively, the camera body 50 may be provided with the table data 24, the body processor 58 may perform the processing shown in FIG. 6, and the body processor 58 may output the control signal for driving the stop 4 to the stop drive unit 14 without going through the lens processor 8. In this case, the body processor 58 may output the control signal to the variable magnification lens drive unit 12 and the focus lens drive unit 16 without going through the lens processor 8. That is, the body processor 58 may realize the “processor” that controls the opening amount of the stop 4 according to the technique of the present disclosure. FIG. 7 shows a functional configuration diagram of a camera system 200 as a modification example configured in this manner.

The camera system 200 of FIG. 7 comprises a lens unit 210 and a camera body 250 to which the lens unit 210 is attachably and detachably mounted in a communicable manner. The camera body 250 is provided with a mount 30 to which the lens unit 210 is attachably and detachably mounted. With the mount of the lens unit 210 on the mount 30, the lens unit 210 and the camera body 250 are electrically connected to each other.

The camera system 200 of FIG. 7 is mainly different from the camera system 100 of FIG. 1 in the following points. The camera body 250 comprises a memory 20 and a storage 22. In the camera system 200, the variable magnification state detection unit 13, the opening diameter detection unit 15, and the focus detection unit 17 each output detection results to the body processor 58 included in the camera body 250 via the mount 30. In the camera system 200, the variable magnification lens drive unit 12, the stop drive unit 14, and the focus lens drive unit 16 receive the control signal from the body processor 58 via the mount 30. In a case where the information on the variable magnification state is received from the variable magnification state detection unit 13, the body processor 58 refers to the table data 24 in the storage 22 to acquire the target opening diameter corresponding to the variable magnification state and outputs the control signal to the stop drive unit 14 such that the opening diameter is the same as the target opening diameter in a case where the opening diameter is different from the target opening diameter. Alternatively, a lens driver integrated circuit (IC) that receives the control signal from the body processor 58 and outputs the control signal to the variable magnification lens drive unit 12, the stop drive unit 14, and/or the focus lens drive unit 16 may be provided in the lens unit 210.

### Example of Zoom Lens

Next, the Example of the zoom lens 1 will be described. FIG. 8 shows a configuration of the zoom lens 1 in a cross section including the optical axis AX of one Example. In FIG. 8, a left side is an object side and a right side is an image side. The zoom lens 1 of FIG. 8 consists of five lens groups in which spacings between adjacent lens groups change during changing the magnification. More specifically, the zoom lens 1 of FIG. 8 consists of, in order from the object side to the image side along the optical axis AX, a first lens group G1 having a positive refractive power, a second lens group G2 having a negative refractive power, a third lens group G3 having a positive refractive power, a fourth lens group G4 having a negative refractive power, and a fifth lens group G5 having a positive refractive power. A parallel flat plate-like optical member PP assuming various filters and/or a cover glass or the like is disposed between the fifth lens group G5 and an image plane Sim.

The configuration consisting of the five lens groups is advantageous in achieving a high variable magnification ratio. Further, with setting of the first lens group G1 as a lens group having a positive refractive power, the entire length of a lens system can be easily shortened, which is advantageous in achieving both miniaturization and the high variable magnification ratio. With setting of the first lens group G1 as a lens group having a positive refractive power, a height of a light beam incident on the second lens group G2 from the optical axis AX becomes lower, which is advantageous in suppressing aberration variation during changing the magnification.

The first lens group G1 consists of three lenses of lenses L11 to L13 in order from the object side to the image side. The second lens group G2 consists of four lenses L21 to L24 in order from the object side to the image side. The third lens group G3 consists of an aperture stop St and three lenses of lenses L31 to L33 in order from the object side to the image side. The fourth lens group G4 consists of two lenses of lenses L41 to L42 in order from the object side to the image side. The fifth lens group G5 consists of three lenses of lenses L51 to L53 in order from the object side to the image side.

The third lens group G3 includes the aperture stop St. The aperture stop St is an example of a “stop” of the technique of the present disclosure. In such a zoom lens 1 having the five-group configuration, the aperture stop St is preferably disposed between a surface of the second lens group G2 closest to the object side and a surface of the fourth lens group G4 closest to the image side. With the disposition of the aperture stop St in this range is advantageous for miniaturization as compared with a case where the aperture stop St is disposed in the first lens group G1 or the fifth lens group G5.

During changing the magnification, all the spacings of adjacent lens groups change. More specifically, in the example of FIG. 8, during changing the magnification, the first lens group G1, the third lens group G3, and the fifth lens group G5 are fixed to the image plane Sim, and the second lens group G2 and the fourth lens group G4 move along the optical axis AX while changing the spacings between the adjacent lens groups. Ground symbols under each of the first lens group G1, the third lens group G3, and the fifth lens group G5 in FIG. 8 indicate that the lens groups are fixed to the image plane Sim during changing the magnification. Curved arrows below each of the second lens group G2 and the fourth lens group G4 in FIG. 8 indicate a schematic movement locus of each of these lens groups during changing the magnification from the wide angle end to the telephoto end. During focusing, the fourth lens group G4 moves along the optical axis AX. In the example of FIG. 8, the lenses of the second lens group G2 and the fourth lens group G4 function as variable magnification lenses, and the lenses of the fourth lens group G4 also functions as a focus lens.

Regarding the zoom lens 1 of FIG. 8, Table 5 shows basic lens data, Table 6 shows specifications and variable surface spacings, and Table 7 shows aspherical coefficients. The table of basic lens data is described as follows. A column Sn shows a surface number in a case where the surface closest to the object side is set as a first surface and the surface number is increased by one toward the image side. A column R shows a curvature radius of each surface. A column D shows a surface spacing on the optical axis between each surface and a surface adjacent to the image side. A column Nd shows a refractive index of each component with respect to a d line. A column vd shows the Abbe number of each component based on the d line. In the present specification, a wavelength of the d line is 587.56 nanometers (nm).

In the table of the basic lens data, a sign of the curvature radius of a surface having a convex surface facing the object side is positive, and a sign of the curvature radius of the surface having the convex surface facing the image side is negative. The surface number and a phrase of (St) are entered in the column of the surface number of a surface corresponding to the aperture stop St. The optical member PP is also shown in the table of basic lens data. A value in the lowest column of the column D of the table is a spacing between the surface closest to the image side and the image plane Sim in the table. A symbol DD[ ] is used for the variable surface spacing. The surface number of the spacing on the object side is added in [ ], and the symbol is entered in the column D.

Table 6 shows variable magnification ratio ZR, focal length f, back focus Bf at an air conversion distance, F-Number FNo. in an aperture stop state, maximum total angle of view 20, maximum image height IH, and variable surface spacing, based on the d line. [°] in a column of 20 indicates that the unit is degree. In Table 6, each value in a state of being focused on an infinite distance object at the wide angle end is shown in a column labeled “wide angle end_infinite distance”, each value in a state of being focused on an infinite distance object at the telephoto end is shown in a column labeled “telephoto end_infinite distance”, and each value in a state of being focused on a close distance object at the telephoto end is shown in a column labeled “telephoto end_close distance”. However, f and Bf are indicated only for the states of being focused on the infinite distance object. In the present Example, a distance on the optical axis from the lens surface closest to the object side to the close distance object is set to 1.1 meters (m).

In the basic lens data, the surface number of an aspherical surface is marked with *, and a numerical value of a paraxial curvature radius is described in a column of the curvature radius of the aspherical surface. In Table 7, a row of Sn shows the surface number of the aspherical surface, and rows of KA and Am show numerical values of the aspherical coefficient for each aspherical surface. Note that m of Am is an integer of 3 or more and varies depending on the surface. For example, m=4, 6, 8, . . . , 20 on a sixth surface. Note that “E±n” (n: integer) of the numerical value of the aspherical coefficient in Table 7 means “×10^{±n}”. Note that KA and Am are the aspherical coefficients in an aspherical surface equation represented by the following equation.

$$Zd = C \times {h}^{2} / \{ 1 + {( 1 - KA \times {C}^{2} \times {h}^{2} )}^{1 / 2} \} + \sum Am \times {h}^{m}$$

where
Zd: aspherical depth (length of perpendicular line drawn from point on aspherical surface having height h to plane perpendicular to optical axis AX where aspherical surface apex is in contact)
h: height (distance from optical axis AX to lens surface)
C: reciprocal of paraxial curvature radius, and
KA, Am: aspherical coefficient, and
Σ of the aspherical surface equation means a sum related to m.

In the data in each of the following tables, degree is used as the unit of the angle and millimeter (mm) is used as the unit of the length. However, the optical system can be used also in either proportional enlargement or reduction, and thus another suitable unit may be used. Further, in each of the tables shown below, numerical values rounded with digits set in advance are described.

TABLE 5

| Sn | R | D | Nd | vd |
|---|---|---|---|---|
| 1 | 87.49027 | 1.700 | 1.92286 | 20.89 |
| 2 | 52.89620 | 7.910 | 1.59283 | 68.63 |
| 3 | ∞ | 0.120 | | |
| 4 | 44.12034 | 4.790 | 1.77535 | 50.30 |
| 5 | 116.11585 | DD[5] | | |
| *6 | 245.66038 | 1.200 | 1.80610 | 40.73 |
| *7 | 12.68927 | 6.145 | | |
| 8 | −26.73160 | 0.650 | 1.77535 | 50.30 |
| 9 | 50.98602 | 0.120 | | |
| 10 | 31.42270 | 4.540 | 1.84666 | 23.79 |
| 11 | −31.42270 | 0.627 | | |
| 12 | −22.66685 | 0.740 | 1.88299 | 40.78 |
| 13 | −76.75060 | DD[13] | | |
| 14(St) | ∞ | 1.200 | | |
| *15 | 18.36941 | 4.760 | 1.49648 | 81.26 |
| *16 | −48.27179 | 1.190 | | |
| 17 | 29.69112 | 0.810 | 1.91082 | 35.25 |
| 18 | 13.05210 | 6.860 | 1.53775 | 74.70 |
| 19 | −23.87047 | DD[19] | | |
| 20 | −78.14210 | 2.100 | 1.90200 | 25.26 |
| 21 | −18.35250 | 0.610 | 1.78799 | 47.47 |
| 22 | 23.19920 | DD[22] | | |
| *23 | −179.47134 | 5.630 | 1.58313 | 59.46 |
| *24 | −17.00892 | 0.300 | | |
| 25 | −20.28331 | 0.870 | 2.00069 | 25.43 |
| 26 | −53.01793 | 2.410 | | |
| 27 | −170.48426 | 3.950 | 1.53172 | 48.85 |
| 28 | −30.13278 | 21.850 | | |
| 29 | ∞ | 2.850 | 1.51633 | 64.14 |
| 30 | ∞ | 1.022 | | |

TABLE 6

| | Wide angle | Telephoto | Telephoto |
|---|---|---|---|
| | end_infinite | end_infinite | end_close |
| | distance | distance | distance |
| ZR | 1.00 | 6.30 | 6.30 |
| f | 18.547 | 116.847 | — |
| Bf | 24.750 | 24.750 | — |
| FNo. | 4.06 | 4.11 | 4.28 |
| 2ω[°] | 81.4 | 13.4 | 13.0 |
| IH | 14.9 | 14.9 | 14.9 |
| DD[5] | 1.010 | 31.197 | 31.197 |
| DD[13] | 30.990 | 0.803 | 0.803 |
| DD[19] | 1.000 | 12.816 | 15.898 |
| DD[22] | 22.140 | 10.324 | 7.242 |

TABLE 7

| Sn | 6 | 7 | 23 | 24 |
|---|---|---|---|---|
| KA | 1.0000000E+00 | 1.0000000E+00 | 1.0000000E+00 | 1.0000000E+00 |
| A4 | 7.2162182E−05 | 6.3951258E−05 | 6.2558334E−07 | 1.7961844E−05 |
| A6 | −2.4070551E−06 | −1.6240922E−06 | −2.5123777E−07 | 2.5308981E−07 |
| A8 | 6.6292530E−08 | −1.3300528E−08 | 9.6772452E−09 | −1.7409809E−08 |
| A10 | −1.2928618E−09 | 2.9349449E−09 | −9.2663040E−11 | 6.4173328E−10 |
| A12 | 1.6662337E−11 | −1.1360714E−10 | −1.5910064E−12 | −1.2426583E−11 |
| A14 | −1.3767364E−13 | 2.2401189E−12 | 4.8091291E−14 | 1.3729067E−13 |
| A16 | 6.9920905E−16 | −2.4643236E−14 | −4.7819912E−16 | −8.6371114E−16 |
| A18 | 1.9843666E−18 | 1.4358958E−16 | 2.1682041E−18 | 2.8638107E−18 |
| A20 | 2.4073118E−21 | −3.4575521E−19 | −3.7741189E−21 | −3.8577185E−21 |

| Sn | 15 | 16 |
|---|---|---|
| KA | 1.0000000E+00 | 1.0000000E+00 |
| A3 | 0.0000000E+00 | 0.0000000E+00 |
| A4 | −6.0687358E−07 | 5.2748347E−05 |
| A5 | −2.8167628E−05 | −1.5462879E−05 |
| A6 | 1.9630198E−05 | 1.1360978E−05 |
| A7 | −6.0535065E−06 | −3.7763585E−06 |
| A8 | 7.7542404E−07 | 5.9968569E−07 |
| A9 | 6.0985521E−09 | −3.0551057E−08 |
| A10 | −8.1194622E−09 | −2.6503898E−09 |
| A11 | −5.3620339E−10 | 2.3432904E−10 |
| A12 | 2.1704935E−10 | 2.6746174E−11 |
| A13 | −9.6055698E−12 | −5.5244317E−12 |
| A14 | −1.1170760E−12 | 6.6721773E−13 |
| A15 | 1.1369689E−13 | −5.6273681E−14 |
| A16 | −2.8178209E−15 | 1.9621089E−15 |

The above Example is an example, and the variable magnification optical system of the present disclosure can be modified in various ways. For example, the curvature radius, the surface spacing, the refractive index, the Abbe number, and the aspherical coefficient of each lens are not limited to the values shown in the above Examples and may have other values. The number of lens groups constituting the variable magnification optical system of the present disclosure and the number of lenses included in each lens group may be different from the number of the example of FIG. 8. In the example of FIG. 8, the lens group including the aperture stop St is fixed during changing the magnification. However, the lens group including the aperture stop St may be configured to move during changing the magnification. Further, the variable magnification optical system of the present disclosure is not limited to the zoom lens and may be a varifocal lens.

The technique of the present disclosure can be applied not only to the lens-interchangeable digital camera but also to an integrated-lens digital camera. In addition to the digital camera, the technique of the present disclosure can be applied to various optical devices such as a video camera, a camera for movie imaging, and a security camera.

In the above embodiment, an example has been described in which the entire variable magnification region is divided into three or five variable magnification regions for control. However, the number of divisions in the variable magnification region can be randomly changed in the technique of the present disclosure. Further, a method of deciding the target opening amount according to the variable magnification state is not limited to the above example and can be randomly changed. In the above description, an example has been described in which the control is performed by using the table data in which the variable magnification state and the opening amount are associated with each other. However, instead of the table data, the control may be performed by using a function in which the variable magnification state and the opening amount are associated with each other or a relational equation in which the variable magnification state and the opening amount are associated with each other. The above preferred control, preferred configuration, and possible configuration can be randomly selected and randomly combined in accordance with a required specification, in addition to the control in the range satisfying Conditional Expression (1).

The contents described and the contents shown hereinabove are specific descriptions regarding the part according to the technique of the present disclosure and are merely an example of the technique of the present disclosure. For example, the descriptions regarding the configurations, the functions, the actions, and the effects are descriptions regarding an example of the configurations, the functions, the actions, and the effects of the part according to the technique of the present disclosure. Accordingly, in the contents described and the contents shown hereinabove, it is needless to say that removal of an unnecessary part, or addition or replacement of a new element may be employed within a range not departing from the gist of the technique of the present disclosure. In order to avoid complication and easily understand the part according to the technique of the disclosure, in the contents described and the contents shown hereinabove, the description regarding common general technical knowledge which is not necessarily particularly described for performing the technique of the present disclosure is omitted.

In the specification, “A and/or B” is identical to “at least one of A or B”. That is, “A and/or B” may be only A, only B, or a combination of A and B. In the specification, the same description regarding “A and/or B” is applied also in a case of expressing three or more items with the expression of “and/or”.

In a case where all of documents, patent applications, and technical standard described in the specification are incorporated in the specification as references, to the same degree as a case where the incorporation of each of documents, patent applications, and technical standard as references is specifically and individually noted.

What is claimed is:

1. A lens unit comprising:
a variable magnification optical system provided with a stop that adjusts a light amount; and
a processor that controls an opening amount of the stop based on information on a magnification change of the variable magnification optical system, the processor controlling the opening amount within a range satisfying Conditional Expression (la) represented by
$$3 < \{ ( F max - F min ) / Fave \} \times 100 \leq 7.09 \qquad ( 1 a )$$
in a case where a maximum value of an F-Number in an entire variable magnification region of the variable magnification optical system is Fmax,
a minimum value of the F-Number in the entire variable magnification region of the variable magnification optical system is Fmin, and
an average value of an F-Number at a wide angle end and an F-Number at a telephoto end of the variable magnification optical system is Fave.

2. The lens unit according to claim 1,
wherein in a case where a maximum variable magnification ratio of the variable magnification optical system is ZRmax, and
a variable magnification ratio of the variable magnification optical system is ZR,
the F-Number of the variable magnification optical system takes Fmax and Fmin in a variable magnification region of 0.15<{log₁₀(ZR)/log₁₀(ZRmax)}<0.85.

3. The lens unit according to claim 1,
wherein in a case where a maximum variable magnification ratio of the variable magnification optical system is ZRmax, and
a variable magnification ratio of the variable magnification optical system is ZR,
the opening amount is invariable in variable magnification regions of
$$0 < \{ {log}_{10} ( ZR ) / {log}_{10} ( ZR max ) \} < 0.15 , and$$
$$0.85 < \{ {log}_{10} ( ZR ) / {log}_{10} ( ZR max ) \} < 1.$$

4. The lens unit according to claim 1,
wherein in a case where a maximum variable magnification ratio of the variable magnification optical system is ZRmax, and
a variable magnification ratio of the variable magnification optical system is ZR,
a variable magnification region in which the opening amount is changeable is
$$0.15 < \{ {log}_{10} ( ZR ) / {log}_{10} ( ZR max ) \} < 0.85 .$$

5. The lens unit according to claim 1,
wherein the variable magnification optical system consists of,
in an order from an object side to an image side, a first lens group having a positive refractive power, a second lens group having a negative refractive power, a third lens group having a positive refractive power, a fourth lens group having a negative refractive power, and a fifth lens group having a positive refractive power,
all of spacings between adjacent lens groups change during changing magnification, and
the stop is disposed between a surface of the second lens group closest to the object side and a surface of the fourth lens group closest to the image side.
